(19) United States
(12) Patent Application Publication
(10) Pub. No.: US 2010/0230557 A1
(43) Pub. Date: Sep. 16, 2010

(54) AS ACCESSORY FOR USE WITH A PORTABLE DEVICE

(75) Inventor: Roland Ian Healey, Suffolk (GB)

Correspondence Address: Workman Nydegger;1000 Eagle Gate Tower, 60 East South Temple, Salt Lake City, UT, 84111, US

(73) Assignees: Roland Ian Healey, Suffolk (GB); Joseph Marland Brown, Essex (GB)

(21) Appl. No.: 12/404,912

(22) Filed: Mar. 16, 2009

(51) Int. Cl. G06F 3/039

(52) U.S. Cl. 248/118.1

(57) ABSTRACT

An accessory for use with a portable device with a top and bottom surface includes a platform for facilitating the use of a mouse; and a jaw incorporating an upper and a lower portion forming, in use, a gap to receive the side of a portable device; wherein the upper and lower portions are configured to respectively engage, in use, the top and bottom surfaces of said portable device; whereby the jaw releasable secures the accessory to said portable device.

### CROSS-REFERENCE TO RELATED APPLICATIONS

Not applicable.

### BACKGROUND OF THE INVENTION

1. The Field of the Invention

The invention relates to accessories for use with a portable device.

2. The Relevant Technology

The following prior art documents are acknowledged: DE 202004018840, U.S. Pat. No. 5,995,082, U.S. Pat. No. 5,575,578, U.S. Pat. No. 6,353,530, and U.S. 2005/098689.

### SUMMARY OF THE INVENTION

In its broadest independent aspect, the invention provides an accessory for use with a portable device with a top and bottom surface comprising a platform for facilitating the use of a mouse; and a jaw incorporating an upper and lower portion forming, in use, a gap to receive the side of a portable device; wherein said upper and lower portions are configured to respectively engage, in use, the top and bottom surfaces of said portable device; whereby said jaw releasably secures said accessory to said portable device. This configuration is particularly advantageous because it improves the manner in which the accessory is attached. It provides a particularly stable attachment to the side of a laptop. It also allows fitting to a wide variety of different laptops.

In a subsidiary aspect, said jaw incorporates cushioning pads on said upper and lower portions. This allows the accessory to attach without unduly scratching the top and bottom surfaces of a laptop computer. It also allows improved retention of the accessory during use.

In a further subsidiary aspect, said upper portion and said lower portion are spaced in a substantially parallel relationship in order to facilitate sliding over the top and bottom surfaces of said portable device.

In a further subsidiary aspect, said accessory further comprises a bias between said upper and lower portion to tend to draw said upper portion and said lower portion together; whereby said jaw forms a clip for clipping onto, in use, the top and bottom surfaces of said portable device. This allows the accessory to be fitted to a wide variety of portable devices of varying thicknesses. It also improves the level of security of the fitment.

In a further subsidiary aspect, said platform is a continuation of said upper portion. This configuration provides for a particular stable platform which would be less prone to bending and/or breakage.

In a further subsidiary aspect, a downwardly projecting wall is provided between said platform and said lower portion; and a bracket extends between said wall and said platform. This configuration improves the level of retention of the shape throughout various cycles of use.

In a further subsidiary aspect, said platform includes a mouse mat.

In a further subsidiary aspect, said platform incorporates a raised portion extending upwards from said platform onto which, in use, a user's wrist rests. This improves the level of comfort as well as distributing the load in order to improve the stress distribution.

In a further subsidiary aspect, said accessory incorporates a platform portion and at least one jaw portion which is separable from said platform portion. This configuration allows one or more jaw portions to be used and these to be separately replaced if necessary.

In a further subsidiary aspect, said accessory incorporates two distinctive jaws, and a space between the two jaws; wherein at least one jaw is displaceable; whereby the space between the two jaws may be varied. This allows the accessory to fit onto a wide variety of different portable devices.

In a further subsidiary aspect, at least one of said upper and lower portions is displaceable; whereby the gap between the upper and lower portions may be varied.

In a further subsidiary aspect, said platform incorporates a plurality of recesses and at least one jaw portion incorporates a tongue corresponding to at least one of said recesses. This configuration further improves the characteristic of adaptability of the accessory for fitting most if not all laptop sizes and/or similar devices.

### BRIEF DESCRIPTION OF THE DRAWINGS

Various embodiments of the present invention will now be discussed with reference to the appended drawings. It is appreciated that these drawings depict only typical embodiments of the invention and are therefore not to be considered limiting of its scope.

FIG. 1 shows a perspective view of an accessory in accordance with a first embodiment of the invention.

FIG. 2 shows a side elevation of the first embodiment of the invention.

FIG. 3 shows a perspective view of the underside of the first accessory.

FIG. 4 shows the accessory of FIGS. 1, 2, 3 when mounted on the side of a laptop.

FIG. 5 shows a perspective view of the accessory of the preceding Figures with the user's mouse and hand.

FIG. 6A shows a perspective view of a jaw in accordance with a second embodiment of the invention.

FIG. 6B shows the process of assembly of the jaw in accordance with the second embodiment of the invention.

FIG. 6C shows in magnified view the jaw portion engaging side of the body of the jaw.

FIG. 6D shows in magnified view the side of the body of the jaw in accordance with the second embodiment of the invention.

FIG. 7A shows the process of fitting the block in accordance with the second embodiment of the invention.

FIG. 7B shows in cross-sectional view the process of fitting the screw to the block.

FIG. 7C shows in cross-sectional view and in side elevation the assembly of the upper portion to the body of the jaw.

FIG. 8 shows in perspective exploded view the various components forming the accessory.

FIG. 9 shows in perspective view the assembled components of the accessory of the second embodiment of the invention.

FIG. 10 shows in perspective exploded view the various components forming the accessory in accordance with a further embodiment of the invention.

FIG. 11 shows in perspective exploded view the various components forming the accessory in accordance with a further embodiment of the invention.

FIG. 12 shows in perspective exploded view the components forming the accessory in accordance with a further embodiment of the invention.

### DETAILED DESCRIPTION OF THE PREFERRED EMBODIMENTS

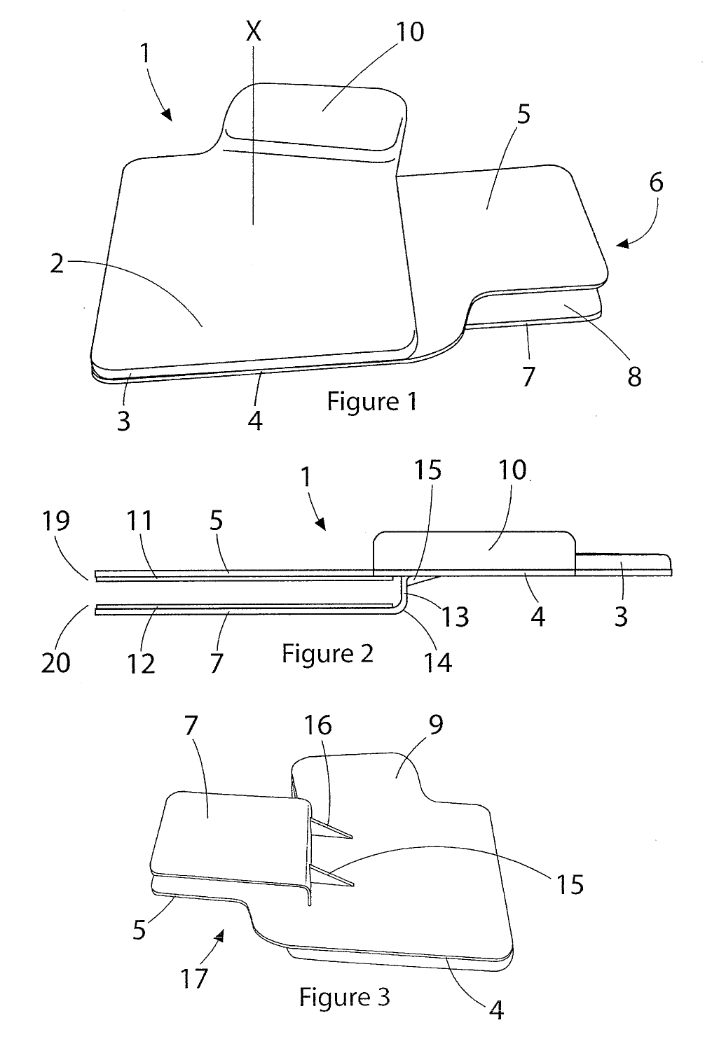

FIG. 1 shows an accessory generally referenced 1 with a platform 2 facilitating the use of a computer mouse. The accessory is shaped and configured to removably attach to a laptop computer, personal digital assistant (PDA), palmtop and/or any portable device with which a mouse may be used. The platform incorporates an upper layer of the kind suitable for the effective operation of a mouse. The upper layer 3 is preferably of resilient polymeric material. It may be formed of a relatively high friction portion lining on a foam polymeric layer or a gel. The mouse mat which is thus formed rests on a relatively rigid support plate 4. The support plate 4 projects beyond the mouse mat in a sideways direction to form the upper portion 5 of a jaw generally referenced 6. The jaw 6 also incorporates a lower portion 7. Jaw portion 5 and jaw portion 7 are separated by a gap 8 sized and shaped for the insertion of the portable device of the kind described above. As part of the platform 2 a further sideways extending portion is provided as reference 9 in FIG. 3. On projection 9, there is provided a wrist rest 10 which may be formed of cushioning material. The wrist rest projection 9 is offset from axis X. This offset is configured to enhance the ergonomic properties of the accessory.

The platform support plate may be relatively rigid compared to the mouse mat. The structure may preferably be of a suitable metal such as aluminum or a relatively rigid polymeric material. The support plate for the jaw portions 5 and 7 may be made of a single piece of material or two or more pieces. As shown in FIG. 3 pads 11 and 12 are provided. These pads may be relatively resilient compared to the support portions 5 and 7. In a preferred configuration, the pads may be classified generally as non-scratch pads. These may also be of rubber or other similarly resilient material such as felt. The thickness of pads may be varied dependent upon the desired gap size. The lower jaw portion 7 joins the upper jaw portion via a substantially upright wall portion 13. A radius 14 is provided between wall portion 13 and lower jaw portion 7. A web/bracket 15 extends between wall portion 13 and platform support 4 in order to assist in maintaining the overall geometry of the accessory. FIG. 3 shows two such webs 15 and 16. These ensure stability and strength of portion 7 in terms of downward movement and/or of portion 13 in terms of sideways movement.

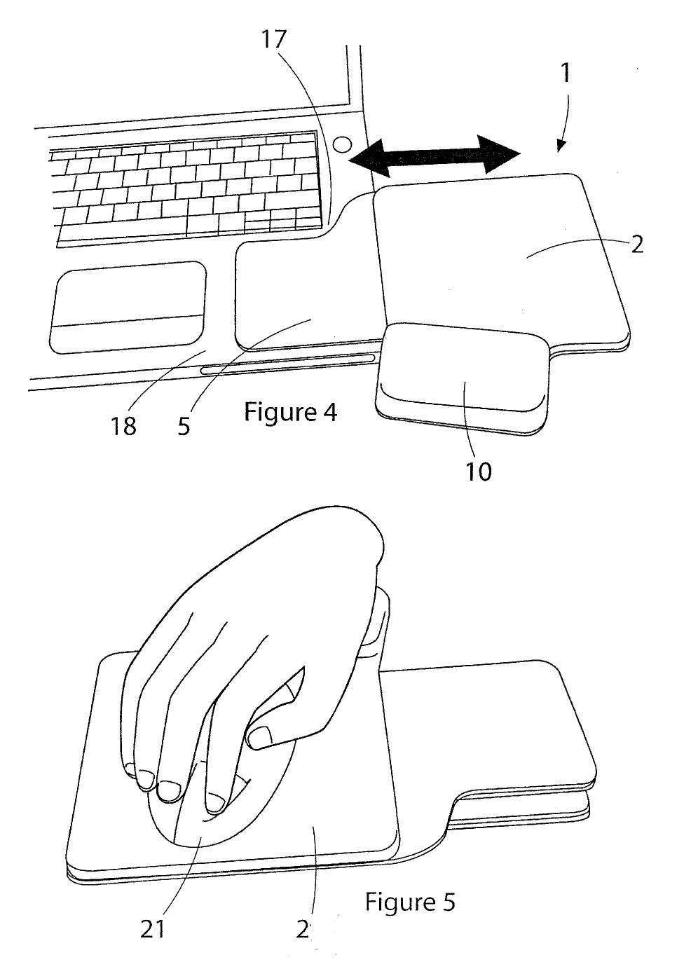

A step 17 is provided between the platform support 4 and the upper jaw portion 5 so that the width of the jaw is reduced relative to the width of the platform. This reduction in width allows the jaw to rest against the upper and lower surfaces of a portable device such as a laptop 18 as shown in FIG. 4.

In FIG. 4, the accessory is sized and shaped to attach sideways onto the laptop 18. Step 17 is shaped and configured to avoid any overlap with the keyboard. Whilst the jaw portions 5 and 7 are substantially parallel in this embodiment, the invention also envisages jaw portions which progressively narrow from wall portion 13 towards their distal extremities respectively referenced 19 and 20. The embodiment of FIG. 4 shows the accessory being able to slide into its position where it is retained primarily by friction onto the upper and lower faces of the laptop 18. In this embodiment, the accessory is retained without any interlock.

The platform 2 as can be seen in FIG. 5 is of sufficient size to accommodate a mouse 21 which could be separately plugged into the laptop. Alternatively, the mouse may wirelessly communicate with the laptop.

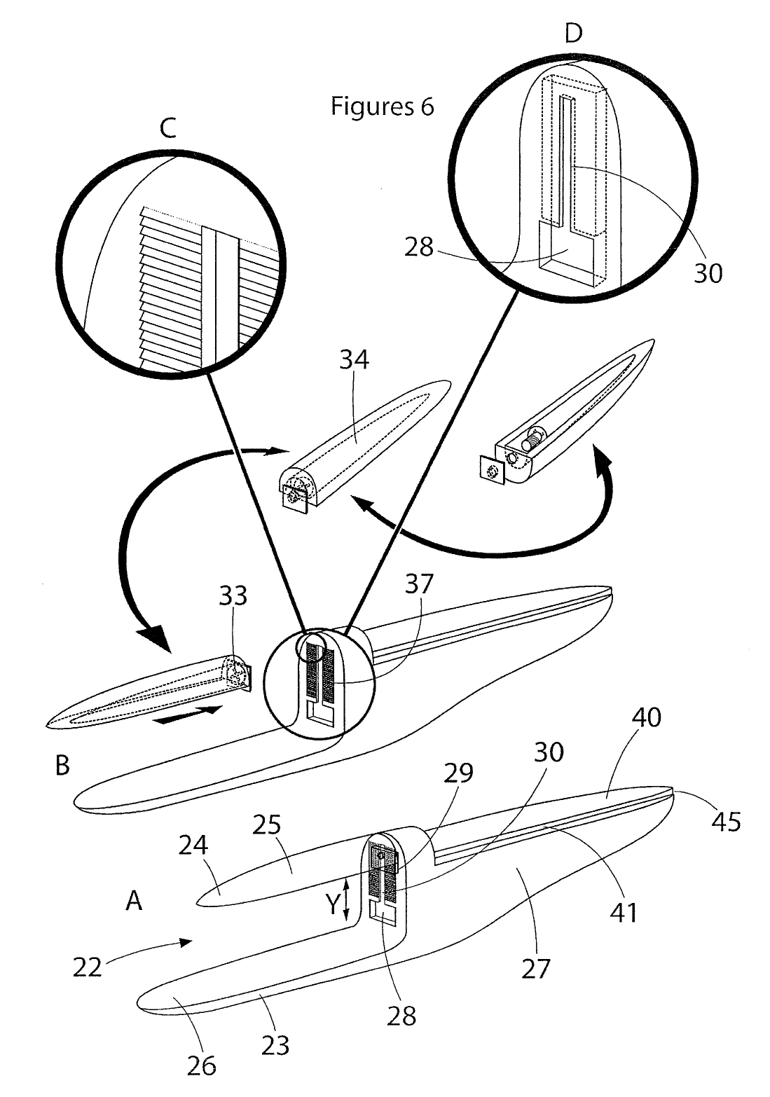

Whilst the embodiments of FIGS. 1 to 5 show an accessory where the jaw portions are integral with the platform and are adjustable either in as much as the inherent material properties allows the accessory to be adjusted or by the addition of protective pads, the embodiment presented in the following Figures shows an accessory where the jaw portions are displaceable in at least two dimensions. FIG. 6 shows a jaw generally referenced 22 which when assembled incorporates a lower jaw portion 23 and an upper jaw portion 24. Each jaw portion incorporates a rounded top surface such as top surface 25 and a relatively flat lap top engaging surface such as surface 26. Jaw portion 24 is configured to displace in the Y direction in order to adjust the gap size allowing the accessory to fit a range of laptop thicknesses. Jaw portion 23 projects from body 27.

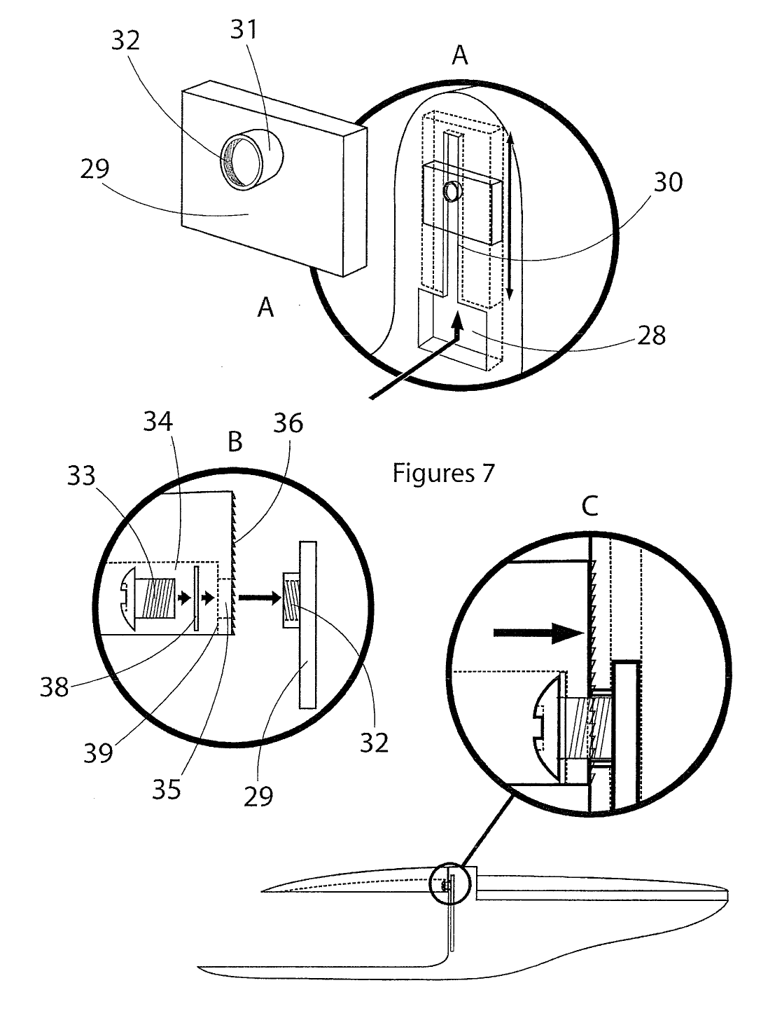

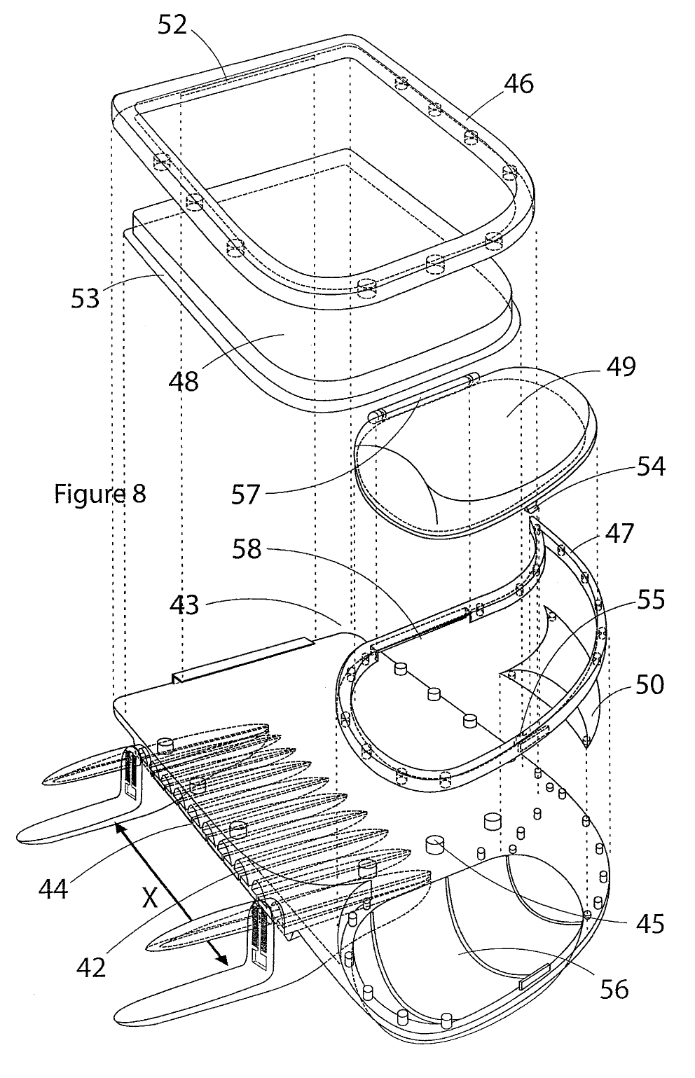

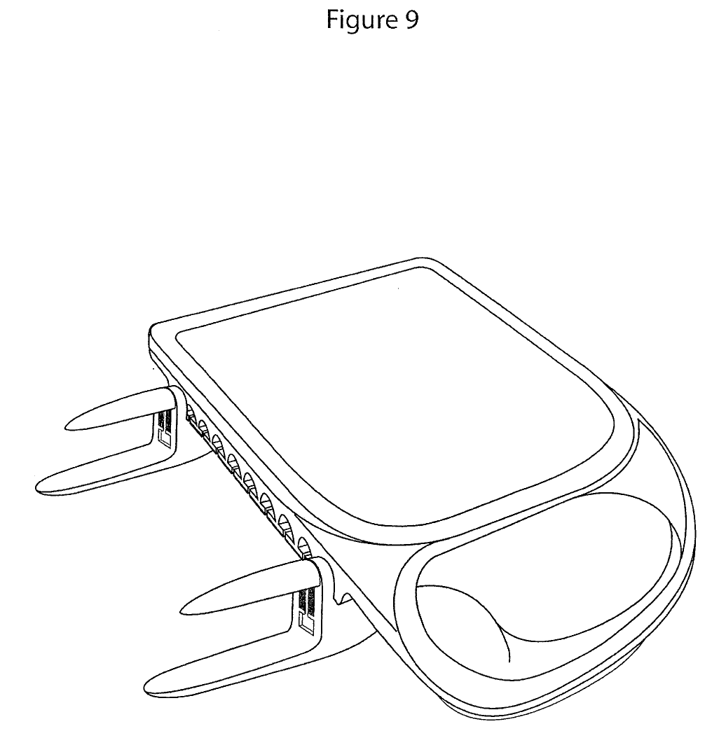

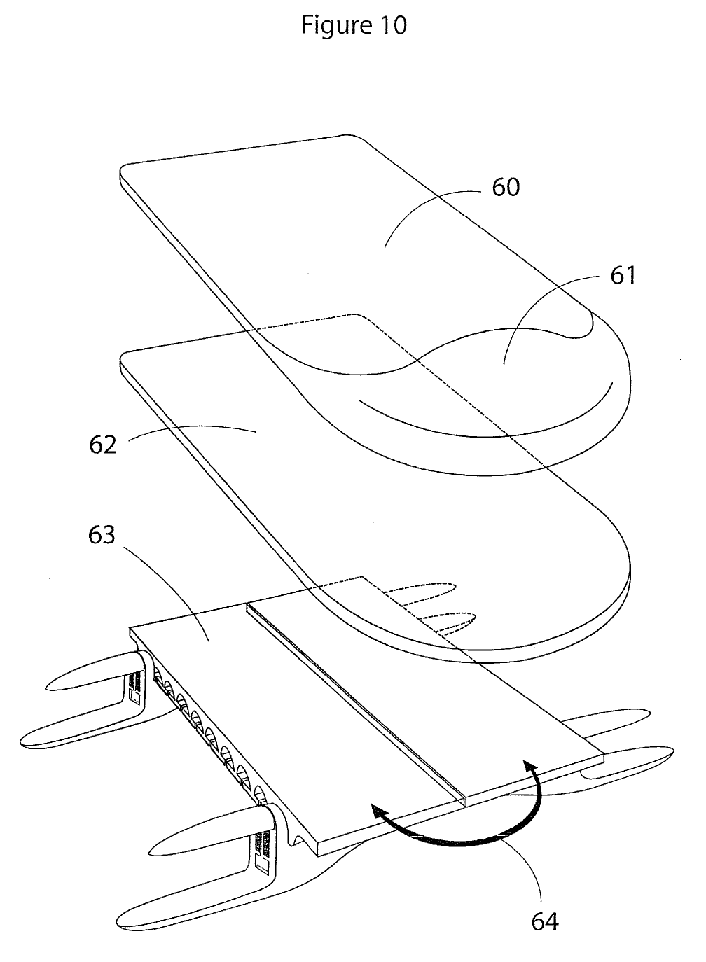

Body 27 incorporates a cavity chamber 28 into which a block 29 as shown in FIG. 7A can fit. A cavity shaft 30 guides the boss 31 in order to locate the block for motion in the Y direction. Boss 31 has an internally threaded portion 32 in order to receive screw 33 as shown in FIG. 6B and FIG. 7B. Screw 33 is hidden inside a cavity 34 and passes through hole 35 in order to engage the threaded portion 32 of block 29. The engaged configuration is shown in FIG. 7C. The front face 36 of jaw portion 24 incorporates an array of ridges for co-operation with corresponding ridges located on face 37 as shown in FIG. 6B and in further detail in FIG. 6C. As an alternative to the ridges, the invention envisages employing a high friction pad or a further array of corresponding projections and recesses. In order to distribute the pressure exerted by the screw on the jaw portion 24 a washer 38 is provided between the screw and the inner surface 39 which surrounds the hole 35. In use, by loosening the screw by employing a screwdriver, body 27 and jaw portion 24 are sufficiently spaced to allow the jaw portion's position to be adjusted by sliding in the Y direction.

Body 27 incorporates a tongue 40. A trough 41 separates the main portion of the body 27 from the tongue 40. This upper portion of the body is shaped and configured to fit recesses such as recess 42 provided in the platform 43 (see FIG. 8). Each recess takes the form of a tunnel corresponding in size to the tongue 40 and facilitates sliding engagement with the tongue. A guide 44 locates extremity 45 in FIG. 6A as the jaw is inserted into one of the recesses. The recesses are substantially parallel with one another and allow the position of the jaws to be varied in the X direction.

A number of upwardly projecting members such as member 45 are provided at regular intervals on the platform 43. These projections correspond to recesses located in a frame member 47 such as mat frame 46 and wrist rest 49. The frames are designed to surround a mouse mat 48 and a wrist rest 49. The wrist rest 49 fits into the hollow portion 56 provided in the platform. The wrist rest incorporates a projection 57 for fitting into a slot 58 of the frame 47. A second projection 54 is provided to extend laterally into a further slot 55 provided in frame 47. A relatively rigid shell 50 is provided to one side of the wrist rest. Whilst the array of projecting members are envisaged to secure the respective frames, further securing mechanisms are envisaged such as filamentary hook and eye pads, and projections located on the frames corresponding to recesses provided in the platform. A lip 51 slides into a slot 52 of the mat frame in order to secure the frame and line it up in order to allow the projections and recesses to fit together.

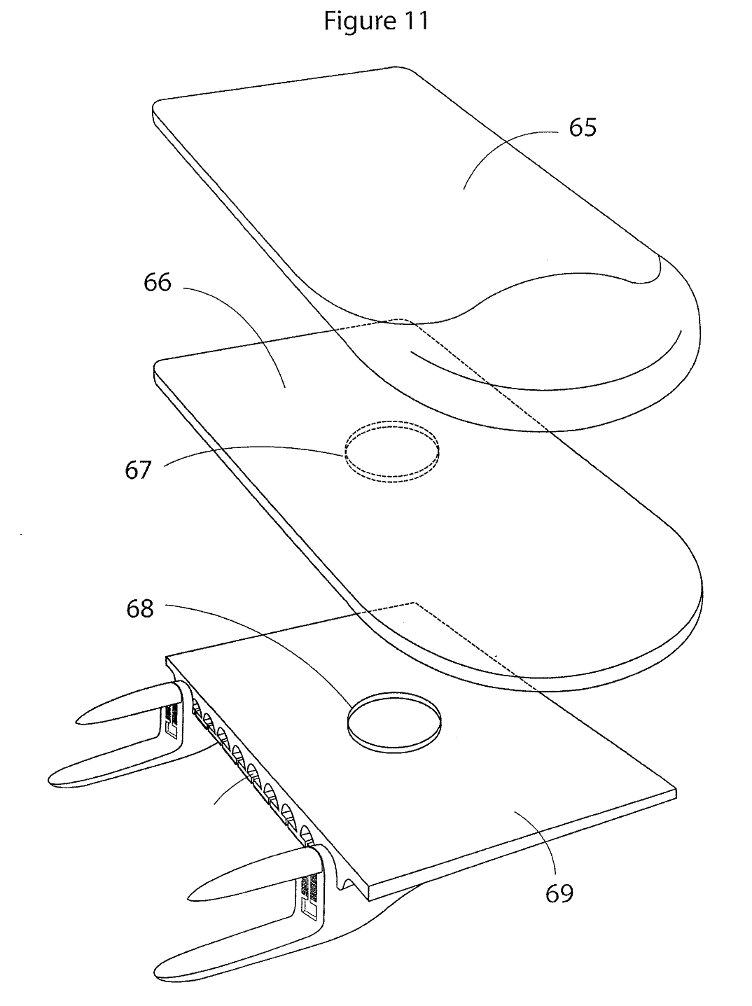

The assembled accessory is shown in FIG. 9. The previous embodiments have been shown for securing on the right hand side of a laptop or other portable device, the invention envisages similar embodiments configured to fit the left hand side of a laptop or portable device.

Further embodiments are envisaged where a bias or spring is provided between the upper and lower portions of a jaw in order to form a sprung clip type mechanism which may be used to clip the platform to the side of a laptop.

Instead of envisaging that the upper jaw portion on its own displaces relative to the lower portion, it is envisaged that the lower portion may instead of or as well as the portion displace in order to allow the adjustment of the gap between the portions.

FIG. 10 shows a pad 60 incorporating a substantially flat upper surface on which the mouse would be located in use. A wrist rest 61 extends to one side of the mouse mat. The mouse mat 60 is secured to a plate 62 which in turn is secured to a further support plate 63. The attachment between plate 62 and support 63 is such as to allow an attachment where the jaws extend either in a right hand direction or in a left hand direction. Arrow 64 indicates the versatility of the support 63. The figure shows support 63 in either of the two positions.

FIG. 11 shows a mouse mat 65 similar to the mouse mat 60 in FIG. 10. A support plate is located beneath the mouse mat which incorporates a cylindrical recess 67. Instead of a recess a projection 67 may be envisaged. Recess 67 is sized and shaped to engage with a projection 68 extending from the support 69. This embodiment shows how the mouse receiving platform may be rotatable relative to a support in order to allow the accessory to be used on the left hand or the right hand of an accessory.

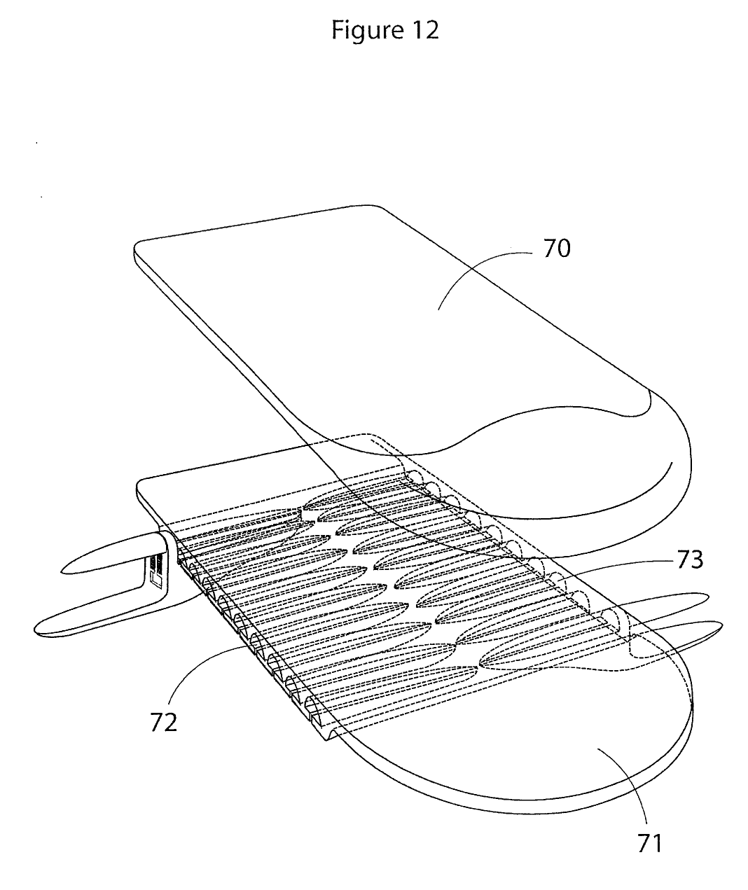

FIG. 12 shows a mouse mat platform 70 which may be secured to a support 71. The support plate has arrays of jaw portion receiving means on both sides of the support 71. These are respectively referenced 72 and 73. The invention also envisages only having an array on either of these sides so that the accessory may be either for left handers or right handers.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An accessory for use with a portable device with a top and bottom surface comprising a platform for facilitating the use of a mouse; and a jaw incorporating an upper and a lower portion forming, in use, a gap to receive the side of a portable device; wherein said upper and lower portions are configured to respectively engage, in use, the top and bottom surfaces of said portable device; whereby said jaw releasably secures said accessory to said portable device.

2. An accessory according to claim 1, wherein said jaw incorporates cushioning pads on said upper and lower portions.

3. An accessory according to claim 1, wherein said upper portion and said lower portion are spaced in a substantially parallel relationship in order to facilitate sliding over the top and bottom surfaces of said portable device.

4. An accessory according to claim 1, further comprising a bias between said upper and lower portion to tend to draw said upper portion and said lower portion together; whereby said jaw forms a clip for clipping onto, in use, the top and bottom surfaces of said portable device.

5. An accessory according to claim 1, wherein said platform is a continuation of said upper portion.

6. An accessory according to claim 5, wherein a downwardly projecting wall is provided between said platform and said lower portion; and a bracket extends between said wall and said platform.

7. An accessory according to claim 1, wherein said platform includes a mouse mat.

8. An accessory according to claim 1, wherein said platform incorporates a raised portion extending upwards from said platform onto which, in use, a user's wrist rests.

9. An accessory according to claim 1, wherein said accessory incorporates a platform portion and at least one jaw portion which is separable from said platform portion.

10. An accessory according to claim 1, wherein said accessory incorporates two distinct jaws, and a space between the two jaws; wherein at least one jaw is displaceable; whereby the space between the two jaws may be varied.

11. An accessory according to claim 1, wherein at least one of said upper and lower portions is displaceable; whereby the gap between the upper and lower portions may be varied.

12. An accessory according to claim 9, wherein said platform portion incorporates a plurality of recesses and at least one jaw portion incorporates a tongue corresponding to at least one of said recesses.
